(19) United States
(12) Patent Application Publication
(10) Pub. No.: US 2013/0297055 A1
(43) Pub. Date: Nov. 7, 2013

(54) NETWORK-BASED CONTROL METHOD AND SYSTEM FOR CONTROLLING A WHOLE-FLOW PRODUCTION PROCESS

(71) Applicant: Fei Wang, Farmingdale, NY (US)

(72) Inventor: Fei Wang, Farmingdale, NY (US)

(21) Appl. No.: 13/464,856

(22) Filed: May 4, 2012

(51) Int. Cl. G05B 19/418

(52) U.S. Cl. 700/96

(57) ABSTRACT

A web-based automation control method and system for controlling a whole-flow production process are provided. The system includes a first production equipment; an inspection equipment; a warehouse controlling instrument designed to collect or monitor some elements concerning warehouse; an environmental parameter controlling instrument for collecting and monitoring variable environment elements; an input/output (I/O) cabinet connected to the first production equipment, the inspection equipment, the warehousing controlling instrument, environmental parameter controlling instrument; a programmable logic controller (PLC) cabinet connected to the I/O cabinet; a switch for connecting the PLC control cabinet with a manufacturing execution systems (MES) server; and a terminal connected to the manufacturing execution systems (MES) server via a communications network.

### BACKGROUND OF THE INVENTION

1. Field of the Invention

The present invention described herein relates generally to a method and system for controlling a whole flow production process in pharmaceutical, metallurgy, food, cosmetics, and aerospace industry enterprises, and in particular, to a network-based control system designed to control whole flow pharmaceutical production process in pharmaceutical enterprises.

2. Description of the Related Art

In a pharmaceutical production facility, there are many factors affecting the quality of pharmaceutical products, as the pharmaceutical regulation of pharmaceutical products quality is stricter and the role of medicine in health care is greater than before. Due to the complicated procedures in pharmaceutical drug production, finished product quality issues or accidents may arise if the pharmaceutical companies don't reinforce the management of quality.

Nowadays, despite equipment used in production process have been improved to relatively high level, the association among the various equipments are still in a low deficiency, which often results in the information of the equipment are isolated from each other and is not beneficial for the corresponding manager to obtain particular information and to take positive measures. During a production process, the manufacturing steps are closely linked and directly and indirectly affect each other. Due to the variable factors which may have a negative effect on the quality of product are too much, there is a need to introduce the conception that integrating all the manufacturing steps and information of equipment to be control into a system, which enable the manufacturing process to run smoothly and sequentially. The quality of the product quality involves all aspects of the production, quality control, warehousing, and throughout the entire production process. Controlling measures should be taken throughout the entire production process and, and involving various concrete production equipment. On the basis of desire for controlling the whole manufacturing process, the connection between field equipments and enterprise management platform should be established, which enable data and information related to the production process to be shared seamlessly, and enable the manufacturing process run smoothly and quality control measures can be based on the data acquired by the system in a standard way.

With the development of industrialization, a pharmaceutical production plant is usually located far away from a plant control room, and meanwhile some enterprises have established their production bases in different cities, so that the traditional control technology cannot meet the requirements of real-time management and control among various production bases, which arouse the need for a system aimed at monitoring and controlling the production process even in thousands of miles away via web-based user terminals.

In summary, it is necessary to develop a set of web-based monitoring and managerial methods and systems which are closely linked with the whole process of the production, integrating the requirements of good manufacturing practice (GMP) and realizing the goal of the monitoring and management on the operating status of the production equipment in the production process, the date acquisition after the detection of quality inspection apparatus, warehouse, and the recording of production-related environmental parameters.

In 1970s, with the LSI making a breakthrough and the proliferation of 8-bit microprocessor, dramatic changes have taken place in the automation instrument industry, among which the centralized computer control system originally at crossroads, immediately absorbed microprocessor technology and became what is now called the computer distributed control system (DCS), also known as distributed control systems which adopted the method of decentralized control, centralized operation and management at different levels, sub-autonomy and comprehensive coordination.

Field bus control system (FCS) approaching the practical use since the 1990s, is developing rapidly and vigorously. And now Field bus control system is a hot topic in the current automation technology, and therefore is increasingly attracting the attention of domestic and foreign automation equipment manufacturers and its target users. The emergence of the Field bus control system will bring another revolution in the field of automation and its depth and breadth will surpass any previous one, thus creating a new era of automation. With the use of field bus, the users can significantly reduce field wiring, achieve multi-variable communication by a single field instrument, interoperate between devices of different factory production and the field-level control functions are increased, system integration is greatly simplified and its maintenance becomes very simple.

Field bus is an industry data bus newly-developed in recent years, which is mainly used for solving the problem of digital communications of on-site facilities such as intelligent instrumentation, controllers, and the implementing agencies, and problems existing in the information transfer between on-site control equipment and advanced control system. So the field bus is both a communications network and self-control network.

### SUMMARY OF THE INVENTION

An aspect of the present invention is to substantially solve at least the above problems and/or disadvantages and to provide at least the advantages below. In order to solve the mentioned-above problems, the present invention, through a distributed control system (DCS) and field bus control system (FCS), adopts new generation technology to solve these problems. Accordingly, one aspect of the present invention is to provide a network-based control method and system for controlling a whole-flow production process.

According to one aspect of the present invention, there is provided a network-base control system for controlling a whole-flow production process. The system includes a first production equipment; an inspection equipment; a warehouse controlling instrument designed to collect or monitor some elements concerning warehouse; an environmental parameter controlling instrument for collecting and monitoring variable environment elements; a input/output (I/O) cabinet connected to the first production equipment, the inspection equipment, the warehousing controlling instrument, environmental parameter controlling instrument; a programmable logic controller (PLC) cabinet connected to the I/O cabinet; a switch for connecting the PLC control cabinet with a manufacturing execution systems (MES) server; and a terminal connected to the manufacturing execution systems (MES) server via a communications network.

According to one embodiment of the present invention, the system also includes an enterprise resource planning (ERP) and a quality management execution system (QMES) server connected to the MES server wherein a terminal can access, extract, transfer and control data and programs from the ERP and QMES server, and the ERP and QMES server includes ERP and QMES software.

According to one embodiment of the present invention, the ERP system includes an accounting, human resource (HR), purchasing, project management, and sales and budgeting system.

According to one embodiment of the present invention, QMES system includes software comprising Quality-by-Design (QBD), materials repository planning (MRP), manufacturing execution system (MES) and laboratory inspection management system (LIMS) system software.

According to one embodiment of the present invention, the system also includes production equipment having specific type of interface connection which can be linked to the switch directly and without connecting to the I/O cabinets and PLC cabinets, wherein the specific type of interface connection port include: RS232, RS485 and RJ45 connectors.

According to one embodiment of the present invention, the production equipments having specific type of interface connection for communicating with a high-performance liquid chromatography (HPLC), UV spectrophotometers (GC), or electronic scales.

According to one embodiment of the present invention, the system includes two PLC controller cabinets comprising a running controller cabinet and a redundant PLC controller cabinet.

According to one embodiment of the present invention, the network communications associated the terminal with manufacturing execution systems server is a way of Ethernet or wireless LAN or cloud computing.

According to yet another embodiment of the present invention, production equipment includes high efficiency wet granulation machines, tablet presses, coating machines and a reactor; and wherein the inspection equipment includes a chemical and biological incubator, a mold incubator and a moisture analyzer, wherein the warehouse controlling instrument includes humidity sensors, humidity actuators, temperature sensors and temperature actuators.

According to still another aspect of the present invention, there is provided a web-based automation control method for controlling a whole flow production process. The method includes connecting an input/output (I/O) cabinet, a production equipment, inspection equipment, a warehousing controlling instruments, an environmental parameter controlling instrument; connecting a programmable logic controller (PLC) cabinet to the input/output (I/O) cabinet; connecting a PLC cabinet to a manufacturing execution system (MES) server; and connecting a terminal to a manufacturing execution systems (MES) server via an Internet network connection.

According to still another aspect of the present invention, there is provided a web-based automation control method for controlling a whole flow production process. The method includes connecting a plurality of input/output (I/O) cabinets to a first production equipment, an inspection equipment, a warehousing controlling instrument, and an environmental parameter controlling instrument; connecting a plurality of programmable logic controller (PLC) cabinets connected to the input/output (I/O) cabinets; connecting a switch between the programmable logic controller (PLC) cabinets and a manufacturing execution systems (MES) server, connecting a plurality of terminals to the manufacturing execution systems (MES) server via an Internet communications network.

The present invention provides the following advantages:

1. The present invention takes the different production equipment used by the various pharmaceutical companies in their production process, and the different production conditions and makes the necessary changes in production accordingly and combines the distributed control system (DCS) and the field bus control system (FCS) to make the most of the advantages of their respective features.

2. Through the use of a field I/O cabinet, an analog signal is converted into a digital signal to avoid the problem that signal strength and stability would be affected because of the long transmission line. Using an I/O cabinet can solve the problem of integrating diffusing-oriented equipment used in data transmitting. Based on such data conversion, digital signal may be transmitted to a PLC control cabinet in a production line, effectively saving the use of transmission cables.

3. By using a set of redundant PLCs in a control cabinet, if one PLC malfunctions, a second PLC is available as an immediate and seamless replacement.

4. Communication conversion modules from Netorus produced by weighing equipment such as electronic weighing scales, electronic scales will transfer the data to the switch after weighing stuff.

5. The means of communication between a terminal and a server network is via an Industrial Ethernet or wireless network or cloud-based network, so as to better manage and control equipment, measuring instruments, and production plant parameters remotely.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram illustrating the architecture of the hardware of the web-based system for controlling the whole flow manufacturing process according to the present invention;

FIG. 2 is a schematic diagram illustrating the detailed architecture of the hardware of the web-based system for controlling the whole flow manufacturing process as shown in FIG. 1 according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

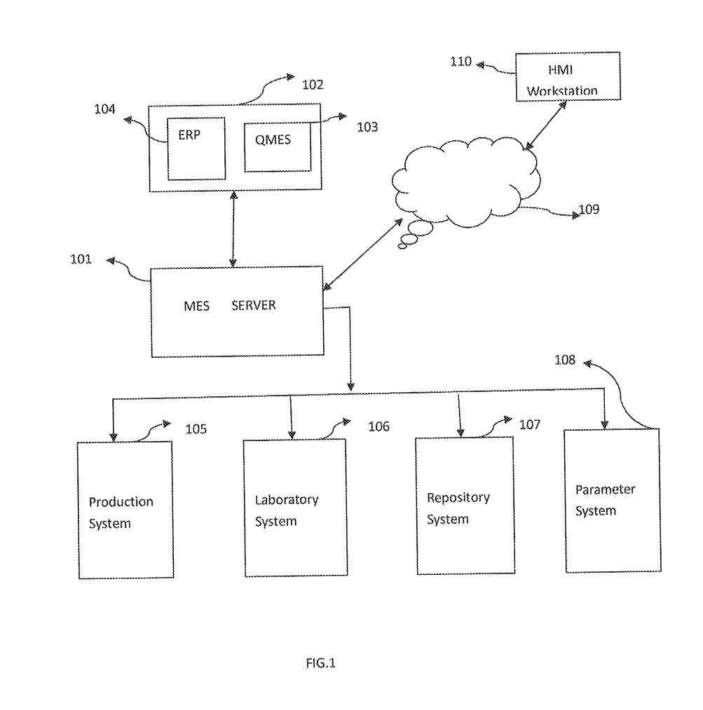

FIG. 1 is a schematic diagram illustrating the architecture of hardware of the web-based system for controlling the whole flow manufacturing process, including a manufacturing execution systems (MES) server 101, in which a database is included for storing all the data concerning the entire manufacturing execution systems, and is used to manage and process, read, write, delete, changes and backup the data that has been stored in a database. In FIG. 1 a production system 105, a laboratory system 106, a warehouse system 107 and a parameter system 108 are connected to the manufacturing execution system (MES) server 101, wherein the production systems 105 includes production equipment and data sensors, data actuators for collecting and controlling data concerning equipment operating, and other some auxiliary equipment. Customized software and hardware makes the production systems 105 compatible with the manufacturing execution systems (MES) server 101, and wherein laboratory system 106 includes laboratory equipment and data sensors, data actuators for collecting and controlling data concerning equipment operating, and other some auxiliary equipment, and those software and hardware make laboratory systems 106 compatible with the manufacturing execution systems (MES) server 101, wherein the storage system 107 includes repository equipment and data sensors, data actuators for collecting and controlling data concerning repository equipment operating, and other some auxiliary equipment, and those software and hardware make storage systems 106 compatible with the manufacturing execution systems (MES) server 101 via compatible hardware and software, and wherein the parameter system 108 includes data sensors, data actuators for collecting and controlling data concerning system operating, and other some auxiliary equipment. The parameter system 108 is communicably coupled to the manufacturing execution systems (MES) server 101 and monitors production running times, temperature, humidity and other parameters of the entire system.

In FIG. 1, the enterprise resource planning (ERP) and quality management execution system (QMES) server 102 linked to manufacturing execution system (MES) 101 includes a database used to store the data contained in the ERP system 104 and in QMES system 103. Based on the connection between ERP and QMES server 102 and the manufacturing execution system 101, ERP systems 104 and QMES system 103 and manufacturing execution system (MES) 101 can communicate, extract, and transmit corresponding data mutually so that the data can be shared among each one.

As further shown in FIG. 1, the connection between the manufacturing execution system (MES) server 101 and human-machine interface (HMI) workstations 110 is achieved by means of communication channel 109 so that an end-user can manage and control the system via the HMI workstation 110. According to one embodiment of the present invention, the means of communication channel 109 can be a local area network (LAN) or a wide area network (WAN). According to another embodiment of the present invention, the means of communication channel 109 can be a cloud-based network.

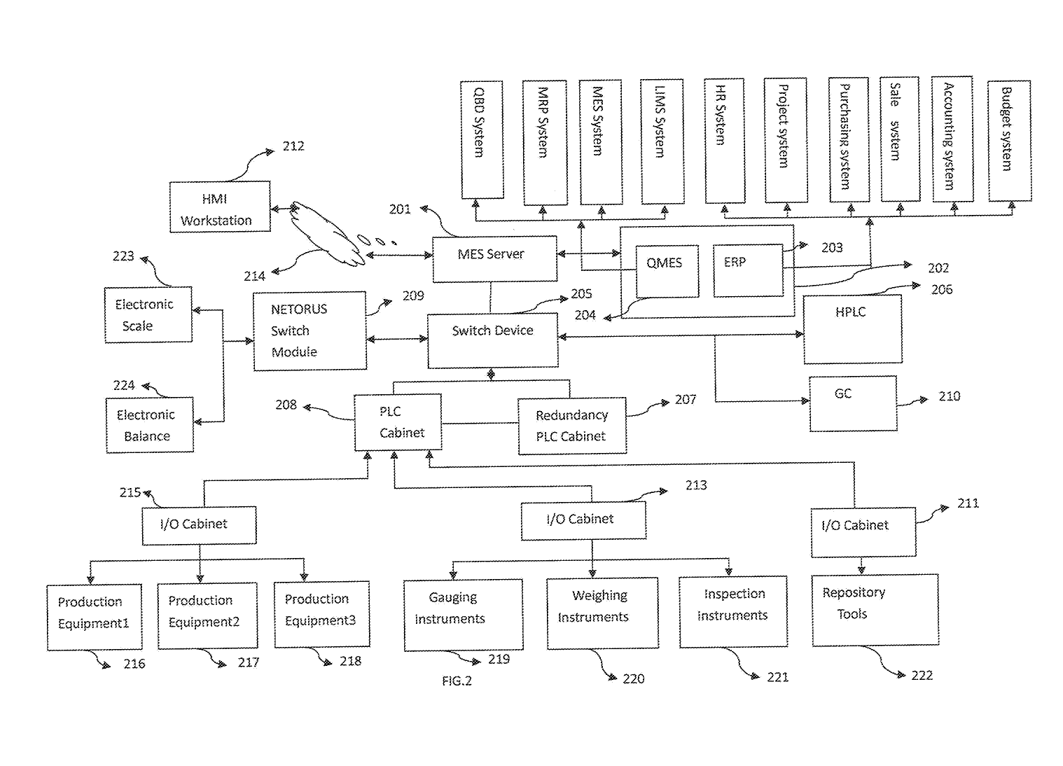

FIG. 2 is a schematic diagram illustrating the detailed architecture of hardware of the web-based system for controlling the whole flow manufacturing process of flow chart as shown in FIG. 1, having various production equipment, measuring tools, testing apparatus and repository instrument for collecting and managing the production process, according to the present invention.

In FIG. 2, the web-based system includes a manufacturing execution system (MES) server 201, a human-machine interface (HMI) workstation 212, a switching device 205, a redundant PLC controller 207, a PLC controller 208, a high-performance liquid chromatography (HPLC) 206, an electronic balance 224 and electronic scales 223, switching communication device 209 facilitated for associating the electronic balance 224 and the electronic scales 223 with the switching device 205, as well as an I/O cabinet devices 211, 213 and 215 used to link to a first field production equipment 216, a second field production equipment 217 and a third field production equipment 218, as well as measuring instruments 219, a weighing apparatus 220, detection tools 221 and a warehouse apparatus 222.

In addition, in FIG. 2, the manufacturing execution system (MES) server 201 is used to store and run a variety of software programs, as well as to store and extract all electronic data that needs to be collected. Switching device 205 is connected to the MES server 201 for the purpose of converting a variety of data inputs into a format such that the MES server 201 can receive and process various data collected from the different field production devices. When data collection methods vary from equipment to equipment, the switching device 205 can be linked directly to equipment having a specific interface for a seamless transferring of data.

As further shown in FIG. 2, the switching device 205 is directly linked to a high-performance liquid chromatography (HPLC) device 206 and a UV spectrophotometer (GC) 210 for rapid data exchange among each other. Switching communication device 209 facilitates the transmission of data between the associating electronic balance 224 and electronic scales 223 with switching device 205 so as to enable the data signal to be sent to switching device 205 so that data can be transferred and collected directly and smoothly. For equipment without a specific data interface, in order to obtain corresponding data from the equipment, data transmission from each can be achieved by way of installing sensors and actuators to each respective equipment as well as a series of conversion and control devices.

Furthermore, in FIG. 2, the switching device 205 is coupled to the programmable logic control (PLC) controllers 207 and 208 wherein the PLC controller 207 serves as a backup when the PLC controller 208 is running successfully. In operation, PLC controllers 207 and 208 work in tandem, wherein the PLC controller 207 is configured to seamlessly replace the role of the PLC controller 208 so as to ensure the whole system runs continuously when the PLC controller 208 is rendered inoperable for any reason. The PLC controller 208 is also shown connected to a series of input/output (I/O) cabinet devices 211, 213, and 215, which are in turn linked to series of field equipment and apparatuses, respectively. In this instance, sensors and actuators will be physically installed onto the on-site plant equipment to enable specific equipment-generated data, such as temperature, speed, or humidity data, for example, to be collected and analyzed, and so proper equipment output can be implemented and maintained.

In FIG. 2, the input/output (I/O) 211 is linked to a warehouse instrument 222, for the purpose of illustration, and in alternative embodiment of the present invention, multiple warehouse instruments maybe linked to the I/O cabinet 211. According to another embodiment of present invention, warehouse instruments connected to the input/output (I/O) 211 may include, but are not limited to: humidity sensor, humidity actuators, temperature sensors and temperature actuators. Input/output (I/O) cabinet 213 is also seen connected to the inspection apparatus 221, weighing apparatus 220 and the measuring apparatus 219. As shown, added inspection and weighing instruments may be connected to the input/output (I/O) cabinet 213. According to one embodiment of the present invention, inspection and weighing instruments connected to the input/output (I/O) cabinet 213 may include, but are not limited to, biochemical incubators, mold incubators and moisture analyzers, for example.

As further shown in FIG. 2, the input/output (I/O) cabinet 215 is connected to plant production equipment 217, 218 and 219. For purposes of illustration and as noted above, additional production equipment may be linked to the input/output (I/O) cabinet 215. According to one embodiment of the present invention, production equipment connected to the input/output (I/O) cabinet 215 may include, but is not limited to, high efficiency wet granulation machines, tablet presses, and coating machine and reactor.

FIG. 2 is shown for the purposes of illustration. It is not intended to be exhaustive or to limit the invention. So it may be apparent for anyone of ordinary skill in the art to practice the invention having one or more I/O cabinet devices and production equipment in combination without departing from the overall scope of the invention.

As shown in FIG. 2, based on the connection between the ERP and QMES server 202 and manufacturing execution system (MES) server 201, ERP systems 204 and QMES system 203 and manufacturing execution system 201 can communicate, extract and transmit corresponding data mutually so that the data can be shared among each other. The ERP and QMES server 202 includes a separate ERP system 203 and QMES system 204. According to the one embodiment of the present invention, the ERP system 203 includes an accounting, HR, purchasing, project management, and a sale and budgeting software sub-system. The QMES system 204 includes a Quality-by-Design (QBD), materials repository plan (MRP), manufacturing execution systems (MES) and laboratory inspection management system (LIMS) computer software sub-system.

As illustrated in FIG. 2, the MES server 201 is connected to an HMI workstation 212 through the network 214. The network 214 may be, for example, a local area network (LAN) or a wide area network (WAN). The network 214 may also be either an Industrial Ethernet-based or a cloud-based computing network according to one aspect of the present invention. In addition, FIG. 2 is a schematic diagram showing only one HMI workstation coupled to the network 214 whereas, in another alternative embodiment of the present invention, multiple HMI workstations may be coupled anywhere along the network 214. As such, production devices, production status, product quality information, material information, warehouse environment parameter and overall production workflow can be managed and controlled effectively.

Advantageously, in one embodiment of the present invention, the enterprise resource planning (ERP) system, manufacture executive system (MES) and field bus control system (FCS) are all shown effectively integrated. The operation status of a plant production process can be easily displayed on a terminal user-interface which allows users, such production managers and personnel, to quickly and conveniently monitor the entire production process on-site or online and to quickly analyze automatically acquired production data. In the case of pharmaceutical drug production and manufacturing, for example, the drug production and overall quality can be effectively controlled by an fully automated and computerized process control system (PAT).

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A web-based automation control system for controlling a whole flow production process, comprising:
a plurality of first production equipment;
a plurality of inspection equipment;
a plurality of warehouse controlling instruments for collecting variable elements concerning a warehouse;
a plurality of environmental parameter controlling instruments for collecting and monitoring variable environment elements;
a plurality of input/output (I/O) cabinet connected to the first production equipment, the inspection equipment, the warehousing controlling instruments, and the environmental parameter controlling instruments;
a plurality of programmable logic controller (PLC) cabinets connected to the input/output (I/O) cabinets;
a switch for facilitating the connection between the programmable logic controller (PLC) cabinets to a manufacturing execution systems (MES) server,
a plurality of terminals connected to the manufacturing execution systems (MES) server via a communications network.

2. The system of claim 1, further comprising an enterprise resource planning (ERP) and quality management execution system (QMES) server connected to the manufacturing execution system (MES) server so that the terminals can access, extract, transfer and control data and software programs from the ERP and QMES server, and wherein the ERP and QMES server includes ERP system software and QMES system software.

3. The system of claim 2, wherein the ERP system includes accounting, human resource (FIR), purchasing, project management, sale and budgeting system software.

4. The system of claim 2, wherein the QMES system includes software comprising Quality-by-Design (QBD), materials repository planning (MRP), manufacturing execution systems (MES) and laboratory inspection management (LIMS) system software.

5. The system of claim 1, further comprising a plurality of second production equipment having a data interface port for connecting to the switch directly without first connecting to the I/O cabinet and the PLC control cabinet, wherein the interface connection port standard is RS232, RS485 and RJ45.

6. The system of claim 5, wherein the second production equipment includes a high-performance liquid chromatography (HPLC) device, UV spectrophotometers (GC) and electronic scales.

7. The system of claim 1, wherein two programmable logic controller (PLC) cabinets comprise a running controller cabinet and a redundant PLC controller cabinet.

8. The system of claim 1, wherein network communication associated with the terminal and manufacturing execution systems (MES) server is via Ethernet, wireless local area network (LAN), or cloud-based computing.

9. The system of claim 1, wherein the first production equipment includes high-efficiency wet granulation machines, tablet presses, coating machines and reactor, wherein the inspection equipment, includes chemical and biological incubators, mold incubators and moisture analyzers, wherein the warehouse controlling instruments includes humidity sensors, humidity actuators, temperature sensors and temperature actuators.

10. A web-based automation control method of controlling a whole flow production process, comprising the steps of:
connecting a plurality of input/output (I/O) cabinets to a first production equipment, an inspection equipment, a warehousing controlling instrument, and an environmental parameter controlling instrument;
connecting a plurality of programmable logic controller (PLC) cabinets connected to the input/output (I/O) cabinets;
connecting a switch between the programmable logic controller (PLC) cabinets and a manufacturing execution systems (MES) server,
connecting a plurality of terminals to the manufacturing execution systems (MES) server via a communications network.

11. The method of claim 10, further comprising connecting an enterprise resource planning (ERP) and quality management execution system (QMES) server to the MES server so that the terminal can access, extract, transfer and control data and programs from the ERP and QMES server, and the ERP and QMES server includes ERP system software and QMES system software.

12. The method of claim 11, wherein the ERP system software includes software comprising accounting, human resource (HR), purchasing, project management, sale and budgeting software.

13. The method of claim 11, wherein QMES system software includes software comprising Quality-by-Design (QBD), materials repository planning (MRP), manufacturing execution systems (MES) and laboratory inspection management system (LIMS) system software.

14. The method of claim 10, further comprising connecting a second production equipment having a data interface port to the switch directly without first connecting to the input/output (I/O) cabinet and the PLC control cabinet, wherein the interface connection port standard is RS232, RS485 and RJ45.

15. The method of claim 14, wherein the second production equipment includes a high-performance liquid chromatography (HPLC) device, UV spectrophotometers (GC) and electronic scales.

16. The method of claim 10, wherein two programmable logic controller (PLC) cabinets comprise a running controller cabinet and a redundant PLC controller cabinet.

17. The method of claim 10, wherein network communication associated with the terminal and manufacturing execution systems (MES) server is via Ethernet, wireless local area network (LAN), or cloud-based computing.

18. The method of claim 10, wherein the first production equipment includes high-efficiency wet granulation machines, tablet presses, coating machines and reactor, wherein the inspection equipment, includes chemical and biological incubators, mold incubators and moisture analyzers, wherein the warehouse controlling instruments includes humidity sensors, humidity actuators, temperature sensors and temperature actuators.
